(19) United States
(12) Patent Application Publication
(10) Pub. No.: US 2007/0155647 A1
(43) Pub. Date: Jul. 5, 2007

(54) Clear or translucent fabric conditioner with a cationic charge booster

(76) Inventors: Hugo Jean Marie Demeyere, Merchtem (BE); Karel Geert Claeys, Oostkamp (BE); Mohammed Zuber, Kobe (JP); Frank Hulskotter, Bad Duerkheim (DE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/445,375

(22) Filed: Jun. 1, 2006

Related U.S. Application Data
(60) Provisional application No. 60/687,581, filed on Jun. 3, 2005.

(51) Int. Cl. C11D 3/00

(52) U.S. Cl. 510/515

(57) ABSTRACT

Cationic charge boosters, wherein the booster has a single alkoxychain, provide clear or translucent compositions with improved softening performance with a lesser amount of softener active.

### CROSS REFERENCE TO RELATED APPLICATION

This application claims the benefit of the filing date of U.S. Provisional Patent Application No. 60/687,581, filed Jun. 3, 2005, the disclosure of which is incorporated by reference herein.

### FIELD OF THE INVENTION

The present invention relates to fabric softening compositions useful for softening fabrics. It especially relates to fabric softening compositions suitable for use in the rinse cycle of a textile laundering operation. The compositions of the invention are translucent or clear liquid softening compositions.

### BACKGROUND OF THE INVENTION

Clear or translucent fabric softening compositions having lower amounts of fabric softening compound(s), wherein the performance of the fabric softener compound is enhanced by the presence of a cationic charge booster system has been reported. Clear fabric softening compositions have traditionally relied upon higher concentrations of fabric softener actives to maintain a consumer acceptable level of softening performance. However, compositions containing such increased levels of softener actives have also relied upon higher levels of solvents in order to maintain a clear or translucent product.

Cationic charge boosting system suitable that provide an increased or “boosted” fabric softening capacity have been suggested as a means for boosting the overall charge density of the fabric conditioning product so as to provide the consumer with a better fabric care benefit without resorting to the use of larger amounts of softener compound(s) and the higher solvent levels that would typically be required to accompany the active in clear and translucent softener compositions. See e.g., WO 03/016447; WO 99/27050. However, there is a continuing need to identify cationic charge boosting systems that maximize softening performance of softener compound(s) in clear or translucent fabric softening composition.

### SUMMARY OF THE INVENTION

It has now been surprisingly discovered that the addition of a specific type of cationic charge boosting system will sufficiently increase the performance of cationic fabric softener actives having diminished or insufficient charge density, to a level that allows higher softening effect when the composition is used in a rinse solution containing anionic surfactant carried over from the wash cycle.

The cationic charge boosting agents of the present invention have the effect of increasing the net cationic charge concentration independent of the intrinsic properties of the softener active. Therefore, the formulator may combine fabric softening compound(s) having low cationic charge capacity, but which have other desirable properties inter alia good dispensability, low melting point, etc., with cationic charge booster systems thereby obtaining a composition which overcomes the lack of cationic charge density of the fabric softener compounds.

The cationic charger boosting agents of the present invention provide the additional benefit of scavenging anionic surfactant that is commonly carried over from the wash water to the rinse. The combined effect of scavenging anionic surfactant that would otherwise tend to interact with a cationic fabric softener compound and of increasing the cationic charge concentration serve to boost the softening effect of the fabric softener compound. This combined effect enables the formulator to obtain a greater softening effect from a given level of softener active.

A first aspect of the present invention relates to a clear or translucent fabric softener compositions comprising: (a) a fabric softening compound; (b) a principal solvent having a ClogP of from −0.2 to 1.0; and (c) a cationic charge booster system.

The charge booster systems useful in the compositions of the present invention have the general formula: 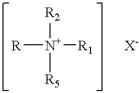
wherein R is a C₈-C₂₂ alkyl or alkenyl; R¹ and R5 are each independently C₁-C₆ alkyl; X— is a fabric softener compatible anion; R² is a polyalkyleneoxy unit having the formula:
(R³O)ₓR⁴
wherein R³ is ethylene, 1,2-propylene, and mixtures thereof; x has a value from 1 to 4; R⁴ is hydrogen or C₁-C₄ alkyl. For purposes of the present invention, the alkyl or alkenyl may be linear, cyclic or branched, and substituted or unsubstituted.

The present invention further relates to methods for boosting the softening activity of fabric softening compositions by admixing a fabric softener composition with a cationic charge boosting system according to the present invention.

### DETAILED DESCRIPTION OF THE INVENTION

### I. Cationic Charge Booster System

The compositions of the present invention comprise at least about 0.1%, preferably at least about 0.2%, and less than about 10%, and preferably less than about 5% by weight, of a cationic charge booster system.

The cationic charge booster systems of the present invention comprise compounds having the general formula: 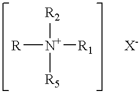
wherein R, R¹, R², and R⁵ are as previously defined. The ethoxylated quaternary compounds described in the prior art are typically produced by ethoxylation of a N,N di(2-hydroxyethyl) N-alkylamine, followed by a quaternization of the ethoxylated alkylamine by a classical alkylating agent such as methylchloride. In contrast, the compounds of the present invention contain only one alkoxychain and are therefore produced via a different synthetic route, such as quaternization by a classical alkylating agent of an N-methyl, N-alkoxy, N-alkylamine.

Examples of the cationic charge boosters of the present invention include Praepagen HY from Clariant Iberica; Empigen 5141 from Huntsman; and AT 412 from Dai-ichi Kogyo Seiyaku Co. Ltd. (DKS, Japan). Praepagen HY has the chemical name N-2 hydroxyethyl, N-cocoyl, N,N dimethyl ammoniumchloride.

### II—Fabric Softening Compound

Another aspect of the invention provides a fabric softening compound. The fabric softener compound is preferably selected from a cationic, non-ionic, amphoteric or anionic fabric softening component. Typical of the cationic softening components are the quaternary ammonium compounds or amine precursors thereof as defined hereinafter. Typical levels of incorporation of the softening compound in the softening composition are of from 1% to 80% by weight, preferably from 5% to 75%, more preferably from 15% to 70%, and even more preferably from 19% to 65%, by weight of the composition.

Non-limiting examples of fabric softening compounds are provided:

A)-Quaternary Ammonium Fabric Softening Active Compound

1) Preferred quaternary ammonium fabric softening active compound have the formula 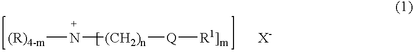
or the formula: 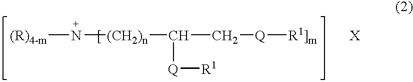
wherein Q is a carbonyl unit having the formula: 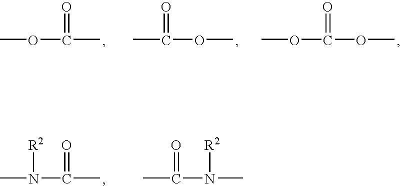
each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener actives and adjunct ingredients; the index m is from 1 to 4, preferably 2; the index n is from 1 to 4, preferably 2.

An example of a preferred fabric softener active is a mixture of quaternized amines having the formula: 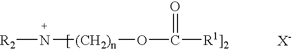
wherein R is preferably methyl; R¹ is a linear or branched alkyl or alkenyl chain comprising at least 11 atoms, preferably at least 15 atoms. In the above fabric softener example, the unit —O₂CR¹ represents a fatty acyl unit which is typically derived from a triglyceride source.

The preferred fabric softening actives of the present invention are the Diester and/or Diamide Quaternary Ammonium (DEQA) compounds, the diesters and diamides having the formula: 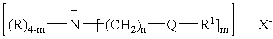
wherein R, R¹, X, and n are the same as defined herein above for formulas (1) and (2), and Q has the formula: 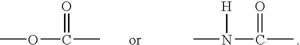
These preferred fabric softening actives are formed from the reaction of an amine with a fatty acyl unit to form an amine intermediate having the formula: 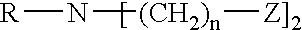
wherein R is preferably methyl, Z is —OH, —NH₂, or mixtures thereof; followed by quaternization to the final softener active. Non-limiting examples of amine used to form the DEQA fabric softening compounds of the present invention are described in US 2002/0035053 A1, published Mar. 21, 2002 at paragraphs 68-73.

As described herein before, R units are preferably methyl, however, suitable fabric softener actives are described by replacing the term “methyl” in the above examples in Table I with the units “ethyl, ethoxy, propyl, propoxy, isopropyl, butyl, isobutyl and t-butyl.

Other DEQA fabric softening compounds described herein that can be used in the preparation of the fabric softening composition herein and having desirable levels of unsaturation, and their syntheses, are described in U.S. Pat. No. 5,877,145, of Errol H. Wahl et al.

Table I. Fabric Softener Compounds

N,N-di(tallowyl-oxy-ethyl)-N,N-dimethyl ammonium chloride;
N,N-di(canolyl-oxy-ethyl)-N,N-dimethyl ammonium chloride;
N,N-di(tallowyl-oxy-ethyl)-N-methyl, N-(2-hydroxyethyl)ammonium chloride;
N,N-di(canolyl-oxy-ethyl)-N-methyl, N-(2-hydroxyethyl)ammonium chloride;
N,N-di(2-tallowyloxy-2-oxo-ethyl)-N,N-dimethyl ammonium chloride;
N,N-di(2-canolyloxy-2-oxo-ethyl)-N,N-dimethyl ammonium chloride
N,N-di(2-tallowyloxyethylcarbonyloxyethyl)-N,N-dimethyl ammonium chloride;
N,N-di(2-canolyloxyethylcarbonyloxyethyl)-N,N-dimethyl ammonium chloride;
N-(2-tallowoyloxy-2-ethyl)-N-(2-tallowyloxy-2-oxo-ethyl)-N,N-dimethyl ammonium chloride;
N-(2-canolyloxy-2-ethyl)-N-(2-canolyloxy-2-oxo-ethyl)-N,N-dimethyl ammonium chloride;
N,N,N-tri(tallowyl-oxy-ethyl)-N-methyl ammonium chloride;
N,N,N-tricanolyl-oxy-ethyl)-N-methyl ammonium chloride;
N-(2-tallowyloxy-2-oxoethyl)-N-(tallowyl)-N,N-dimethyl ammonium chloride;
N-(2-canolyloxy-2-oxoethyl)-N-(canolyl)-N,N-dimethyl ammonium chloride;
1,2-ditallowyloxy-3-N,N,N-trimethylammoniopropane chloride; and
1,2-dicanolyloxy-3-N,N,N-trimethylammoniopropane chloride;
Ditallow dimethyl ammonium chloride;
Dicanoyl dimethyl ammonium chloride;
   and mixtures of the above actives.

Other examples of quaternary ammonium softening compounds are methylbis(tallowamidoethyl)(2-hydroxyethyl)ammonium methylsulfate and methylbis(hydrogenated tallowamidoethyl)(2-hydroxyethyl)ammonium methylsulfate; these materials are available from Witco Chemical Company under the trade names Varisoft® 222 and Varisoft® 110, respectively. Particularly preferred are N,N-di(canolyl-oxy-ethyl)-N,N-dimethyl ammonium chloride and N,N-di(canolyl-oxy-ethyl)-N-methyl, N-(2-hydroxyethyl)ammonium methyl sulfate.

The counter ion, X⁻, in the examples of Table II can be suitably replaced by bromide, methylsulfate, formate, sulfate, nitrate, and mixtures thereof. In fact, the anion, X⁻, is merely present as a counterion of the positively charged quaternary ammonium compounds. The scope of this invention is not considered limited to any particular anion.

As used herein, when the diester is specified, it will include the monoester that is normally present in manufacture. For softening, under no/low detergent carry-over laundry conditions the percentage of monoester should be as low as possible, preferably no more than about 2.5%. However, under high detergent carry-over conditions, some monoester is preferred. The overall ratios of diester to monoester are from about 100:1 to about 2:1, preferably from about 50:1 to about 5:1, more preferably from about 13:1 to about 8:1. Under high detergent carry-over conditions, the di/monoester ratio is preferably about 11:1. The level of monoester present can be controlled in the manufacturing of the softener compound.

Mixtures of actives of formula (1) and (2) may also be prepared.

2) Still other suitable quaternary ammonium fabric softening compounds for use herein are cationic nitrogenous salts having two or more long chain acyclic aliphatic C₈-C₂₂ hydrocarbon groups or one said group and an arylalkyl group which can be used either alone or as part of a mixture such as those described in US 2002/0035053 A1 at paragraphs 93 to 99.

B)-Amine Fabric Softening Active Compound

Suitable amine fabric softening compounds for use herein, which may be in amine form or cationic form as described in US 2002/0035053 A1 paragraphs 101 to 127.

Of course, the term “softening compound” can also encompass mixed softening active compounds. Preferred among the classes of softener compounds disclosed herein before are the diester or diamido quaternary ammonium fabric softening active compound (DEQA). The fabric softener actives herein described are employed in clear or translucent formulations. In one embodiment, the composition is clear.

### III—Principal Solvent

Another aspect of the invention provides a principle solvent. The principal solvent is typically used at a level of less than 40% by weight, preferably below 25%, more preferably from 2% to 10%, by weight of the composition.

The principal solvent is selected to minimize solvent odor impact in the composition and to provide a low viscosity to the final composition. For example, isopropyl alcohol is not very effective and has a strong odor. n-Propyl alcohol is more effective, but also has a distinct odor. Several butyl alcohols also have odors but can be used for effective clarity/stability, especially when used as part of a principal solvent system to minimize their odor. The alcohols are also selected for optimum low temperature stability, that is they are able to form compositions that are liquid with acceptable low viscosities and translucent, preferably clear, down to 40° F. (4.4° C.) and are able to recover after storage down to 20° F. (6.7° C.).

The suitability of any principal solvent for the formulation of the liquid, preferably clear, fabric softener compositions herein with the requisite stability is surprisingly selective. Suitable solvents can be selected based upon their octanol/water partition coefficient (P). Octanol/water partition coefficient of a principal solvent is the ratio between its equilibrium concentration in octanol and in water. The partition coefficients of the principal solvent ingredients of this invention are conveniently given in the form of their logarithm to the base 10, logP.

The logP of many ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each ingredient, and takes into account the numbers and types of atoms, the atom connectivity, and chemical bonding. These ClogP values, which are the most reliable and widely used estimates for this physicochemical property, are preferably used instead of the experimental logP values in the selection of the principal solvent ingredients which are useful in the present invention. Other methods that can be used to compute ClogP include, e.g., Crippen's fragmentation method as disclosed in J. Chem. Inf. Comput. Sci., 27, 21 (1987); Viswanadhan's fragmentation method as disclose in J. Chem. Inf. Comput. Sci., 29, 163 (1989); and Broto's method as disclosed in Eur. J. Med. Chem.—Chim. Theor., 19, 71 (1984). The principal solvents herein are selected from those having a ClogP of from −0.2 to 1.0, said principal solvent preferably being at least somewhat asymmetric, and preferably having a melting, or solidification, point that allows it to be liquid at, or near room temperature. Solvents that have a low molecular weight and are biodegradable are also desirable for some purposes. The more asymmetric solvents appear to be very desirable, whereas the highly symmetrical solvents such as 1,7-heptanediol, or 1,4-bis(hydroxymethyl)cyclohexane, which have a center of symmetry, appear to be unable to provide the essential clear compositions when used alone, even though their ClogP values fall in the preferred range.

Operable principal solvents are disclosed and listed below which have ClogP values which fall within the requisite range. These include mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl)ethers, and aryl glyceryl ethers, aromatic glyceryl ethers, alicyclic diols and derivatives, C₃C₇ diol alkoxylated derivatives, aromatic diols, and unsaturated diols. These principal solvents are all disclosed in U.S. Pat. No. 6,323,172.

Particularly preferred principal solvents include hexanediols such as 1,2-hexanediol and 2 methyl 2,4 pentanediol; and C8 diols such as 2-ethyl-1,3-hexanediol and 2,2,4-trimethyl-1,3-pentanediol, ethoxylates of 2,2,4-trimethyl-1,3-pentanediol and ethoxylates of 2-ethyl-1,3-hexanediol; phenoxyethanol, 1,2 cyclohexanedimethanol and 2 methyl 2,4 pentanediol. Most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol, 2 methyl 2,4 pentanediol and mixtures thereof. Even most preferred principal solvents for use herein are selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, 2 methyl 2,4 pentanediol and mixtures thereof. Mixtures of principal solvents can also be used for the purpose of the present invention.

When in such clear or translucent liquid forms, it has been found preferred, in order to improve the stability of the softening composition according to the invention, that the softening compositions have a pH of from 2 to 5, preferably 2.5 to 4.

### IV—Optional Ingredients

Compositions of the present invention may comprise one or more of the following optional ingredients: low molecular weight water soluble solvents; brighteners; dispersibility aids; solid release agents; scum dispersant; bactericides; perfume; chelating agents; enzymes; and other optional ingredients. US 2002/0035053, from paragraphs 144 to 223.

### V. Softness Performance

The standard comparative softness test method consists of washing a 100% cotton load, containing eight terry cotton test tracers, in a domestic washing machine using the recommended dosage of a granular detergent. The respective fabric softener formulations are added to the rinse water during the conditioning rinse cycle. After drying in a conventional air dryer, a panel of expert graders compares the treated tracers to identify any difference in softness and/or feel due to the different compositions.

One aspect of the present invention provides a fabric softening composition free or essentially free of a detersive laundry detergent. In one embodiment, the composition comprises less than 5%, alternatively less than 4%, alternatively less than 3%, alternatively less than 2%, alternatively less than 1%, or alternatively less than 0.5%.

### VI. EXAMPLES

| | EXAMPLE | | | | | |
|---|---|---|---|---|---|---|
| | 1 | 2 | 3 | 4 | 5 | 6 |
| N,N-di(canolyl-oxy-ethyl)- | 20% | 23% | 23% | 25% | 21% | 20% |
| N-methyl, N-(2-hydroxy- | | | | | | |
| ethyl)ammoniummethyl | | | | | | |
| sulfate (100% Active) | | | | | | |
| Ethanol | 2.2% | 2.5% | 2.5% | 2.7% | 2.2% | 2.2% |
| Hexyleneglycol | 6% | 6% | 6% | 6% | 5%% | 7% |
| Neodol 91-8¹ | 2.2% | 2.2% | 2.2% | 3% | 1.1% | 0.5% |
| HCl | 0.03% | 0.03% | 0.03% | 0.025% | 0.035% | 0.04% |
| MgCl₂ | 2.5% | 3% | 2.5% | 3% | 3.0% | 3.5% |
| Praepagen HY²/ | 2% | 1% | | | | — |
| (40% active) | | | | | | |
| Empigen 5141³ | — | — | 1% | 0.5% | — | — |
| (40% active) | | | | | | |
| AT412⁴ | — | — | — | | 2% | 3% |
| (40% active) | | | | | | |
| Benzyl benzoate | 0.7% | 0.7% | 0.95% | 0.95% | 0.95% | 1.00 |
| Perfume | 0.80% | 0.75% | 0.75% | 0.75% | 0.75% | 0.60 |
| DI water | Bal. | Bal. | Bal. | Bal. | Bal. | Bal. |

¹C9-C11 alkyl ethoxylate 8EO, commercial material from Shell.
²Alkyl, hydroxyethyl, dimethyl ammonium chloride, commercial material from Clariant Iberica.
³Alkyl, hydroxyethyl, dimethyl ammonium chloride, commercial material from Huntsman.
⁴Alkyl, hydroxyethyl, dimethyl ammonium chloride, commercial material from Huntsman.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the DETAILED DESCRIPTION OF THE INVENTION are, in relevant part, incorporated herein by reference; the citation of any document is not to be construed as an admission that it is prior art with respect to the present invention

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A clear or translucent fabric softening composition comprising:
a) a fabric softening compound;
b) a principal solvent having a ClogP of from −0.2 to 1.0; and
c) a cationic charge booster systems having the general formula: 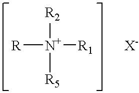
wherein:
(i) R is selected from a C₈-C₂₂ alkyl or a C₈-C₂₂ alkenyl;
(ii) R¹ and R⁵ are each independently a C₁-C₆ alkyl;
(iii) X⁻ is a fabric softener compatible anion;
(iv) R² is a polyalkyleneoxy unit having the formula:
(R³O)ₓR⁴
wherein:
(a) R³ is ethylene, 1,2-propylene, and mixtures thereof;
(b) x has a value from 1 to 4
(c) R⁴ is hydrogen or C₁-C₄ alkyl;

2. The composition of claim 1, wherein the cationic charge booster system being substantially free of di-amino compound based charge boosters.

3. The composition of claim 2, wherein said softening compound has the formula: 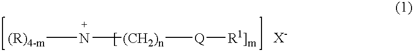
or the formula: 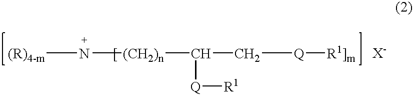
wherein Q is a carbonyl unit having the formula: 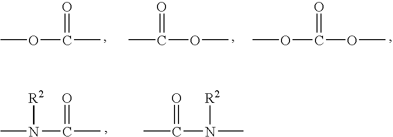
each R unit is independently hydrogen, C₁-C₆ alkyl, C₁-C₆ hydroxyalkyl, and mixtures thereof, preferably methyl or hydroxy alkyl; each R¹ unit is independently linear or branched C₁₁-C₂₂ alkyl, linear or branched C₁₁-C₂₂ alkenyl, and mixtures thereof, R² is hydrogen, C₁-C₄ alkyl, C₁-C₄ hydroxyalkyl, and mixtures thereof; X is an anion which is compatible with fabric softener compound; the index m is from 1 to 4, preferably 2; the index n is from 1 to 4, preferably 2.

4. The composition according to claim 3, wherein said fabric softener compound is present in an amount of from 15% to 70%, by weight of the composition.

5. The composition according to claim 3, wherein said principal solvent is selected from mono-ols, C6 diols, C7 diols, octanediol isomers, butanediol derivatives, trimethylpentanediol isomers, ethylmethylpentanediol isomers, propyl pentanediol isomers, dimethylhexanediol isomers, ethylhexanediol isomers, methylheptanediol isomers, octanediol isomers, nonanediol isomers, alkyl glyceryl ethers, di(hydroxy alkyl) ethers, and aryl glyceryl ethers, aromatic glyceryl ethers, alicyclic diols and derivatives, C₃C₇ diol alkoxylated derivatives, aromatic diols, and unsaturated diols, and mixtures thereof.

6. The composition according to claim 5, wherein the principal solvent is selected from 2,2,4-trimethyl-1,3-pentanediol, ethoxylates of 2,2,4-trimethyl-1,3-pentanediol, 1,2 hexanediol, 2-ethyl-1,3-hexanediol, phenoxyethanol, butyl carbitol, 2 methyl 2,4 pentanediol and mixtures thereof.

7. The composition according to claim 6, wherein said principal solvent is present in an amount from about 2% to about 10%, by weight of the composition.

8. The composition according to claim 7, wherein said composition comprises an effective amount, sufficient to improve clarity, of low molecular weight water soluble solvents selected from the group consisting of: ethanol, isopropanol, propylene glycol, 1,2-propanediol; 1,3-propanediol, propylene carbonate, 1,4 cyclohexanedimethanol and mixtures thereof.

9. The composition according to claim 8, wherein said composition has a pH of from 2 to 5 and is essentially free of a detersive laundry detergent.

10. A method of treating fabrics comprising the step of contacting the fabrics in an aqueous medium containing the softening composition as defined by claim 9.
